(19) United States
(12) Patent Application Publication
(10) Pub. No.: US 2026/0230010 A1
(43) Pub. Date: Aug. 6, 2026

(54) MOTOR DRIVER WITH FAIL-STARTUP FAST RESTARTING MECHANISM

(71) Applicant: ANPEC ELECTRONICS CORPORATION, HSINCHU (TW)

(72) Inventor: MING-JUNG TSAI, CHANGHUA COUNTY (TW)

(21) Appl. No.: 19/180,325

(22) Filed: Apr. 16, 2025

(30) Foreign Application Priority Data
Feb. 5, 2025 (TW) 114104053

(51) Int. Cl. H02P 1/02

(52) U.S. Cl. CPC H02P 1/029; H02P 1/026

(57) ABSTRACT

A motor driver with a fail-startup fast restarting mechanism. The motor driver includes a locking circuit and a motor driving circuit. The locking circuit sets a plurality of locking times during which a motor enters a locked state. In particular, the locking circuit sets at least one of the locking times to be different from other ones of the locking times. The motor driving circuit stops trying to start up the motor within each of the plurality of locking times.

### CROSS-REFERENCE TO RELATED PATENT APPLICATION

This application claims the benefit of priority to Taiwan Patent Application No. 114104053, filed on Feb. 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor driver, and more particularly to a motor driver with a fail-startup fast restarting mechanism.

### BACKGROUND OF THE DISCLOSURE

During operation, circuit components of electronic products generate heat, especially in enclosed casings or other confined spaces. The heat produced by the circuit components circulates within the enclosed casing, heating other circuit components and causing them to overheat and become damaged. Therefore, electronic products must be equipped with a fan to cool the circuit components.

However, sometimes the fan motor fails to startup properly due to factors such as dust accumulation, small foreign objects, or even improper startup program settings. Once a startup failure occurs, the motor enters a locked-rotor/stall protection mechanism, during which the motor remains inactive for a certain period before attempting a restart. Since conventional motor drivers use a fixed time duration before restarting the motor, the restart efficiency is poor.

### SUMMARY OF THE DISCLOSURE

To address the problems in the relevant art, the present disclosure provides a motor driver with a fail-startup fast restarting mechanism. The motor driver of the present disclosure includes a locking circuit and a motor driving circuit. The locking circuit is configured to set a plurality of locking times during which the motor enters a locked state for multiple times. Among the plurality of locking times, at least one of the plurality of locking times is different from the others. The motor driving circuit is connected to the locking circuit and the motor. The motor driving circuit is configured to attempt to start the motor during one or more non-locking periods outside of the plurality of locking times, while stopping motor startup attempts during each of the plurality of locking times.

As described above, the present disclosure provides a motor driver with a fail-startup fast restarting mechanism. The motor driver of the present disclosure can flexibly set the locking time duration for stopping motor startup after each startup failure and configure different locking time durations for multiple startup failures. For example, the motor driver of the present disclosure can set the locking time duration of the first locked state to be shorter than the locking time durations of subsequent locked states. This reduces the waiting time before the second startup attempts, allowing for an earlier retry. Consequently, the motor driver of the present disclosure achieves a higher startup success rate compared to conventional motor drivers.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver with a fail-startup fast restarting mechanism according to a first embodiment of the present disclosure;

FIG. 2 is a block diagram of a motor driver with a fail-startup fast restarting mechanism according to a second embodiment of the present disclosure;

FIG. 3 is a block diagram of a motor driver with a fail-startup fast restarting mechanism according to a third embodiment of the present disclosure;

FIG. 4 is a block diagram of a motor driver with a fail-startup fast restarting mechanism according to a fourth embodiment of the present disclosure;

FIG. 5 is a circuit diagram illustrating the output stage circuit and the motor configuration of the motor driver with a fail-startup fast restarting mechanism according to the fourth embodiment of the present disclosure;

FIG. 6 is a waveform diagram of signals in the motor driver with a fail-startup fast restarting mechanism according to the first to fourth embodiments of the present disclosure;

FIG. 7 is a waveform diagram of signals in the motor driver with a fail-startup fast restarting mechanism according to the second to fourth embodiments of the present disclosure; and

FIG. 8 is a schematic diagram illustrating a plurality of locking times corresponding to multiple accumulated motor lock transitions in the motor driver with a fail-startup fast restarting mechanism according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

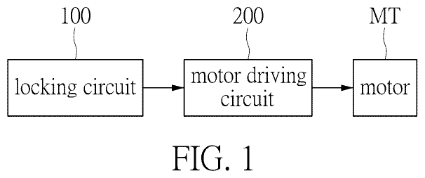

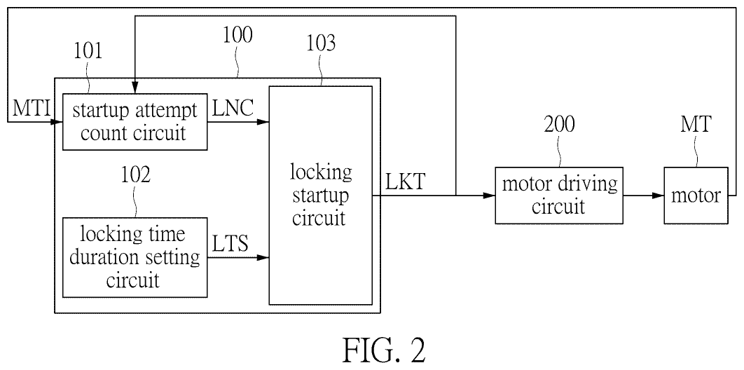

Reference is made to FIG. 1 and FIG. 2. FIG. 1 is a block diagram of a motor driver with a fail-startup fast restarting mechanism according to the first embodiment of the present disclosure, and FIG. 2 is a waveform diagram of signals in the motor driver with a fail-startup fast restarting mechanism according to the first to fourth embodiments of the present disclosure.

The motor driver of the present disclosure includes a locking circuit 100 and a motor driving circuit 200, as shown in FIG. 1. The motor driving circuit 200 is connected to the locking circuit 100 and the motor MT.

As shown in FIG. 1, the motor driver of the present disclosure is applicable to starting the motor MT, such as but not limited to a fan motor MT. The motor MT applicable to the motor driver of the present disclosure includes a single-phase motor, a three-phase motor, or a combination thereof.

Occasionally, dust, small foreign objects, or other obstacles may interfere with the startup of the motor MT, causing the fan to fail to start. When obstacles or other factors prevent the motor MT from starting properly, both conventional motor drivers and the motor driver of the present disclosure execute a locked-rotor/stall/lock protection mechanism, stopping the motor MT from attempting startup for a certain period. This period is referred to herein as the locking time, during which the motor MT remains in a locked state and cannot be restarted.

It is noteworthy that conventional motor drivers use a fixed locking time duration for each transition of motor MT locking, meaning that all of the plurality of locking times are the same. This results in unnecessary delays in restarting the motor MT. To address this issue, the motor driver of the present disclosure allows flexible configuration of different locking times for multiple transitions of the motor MT entering the locked state, as described below.

The locking circuit 100 of the motor driver of the present disclosure sets a locking time whenever the motor MT enters a locked state and generates a locking signal based on the configured locking time.

It is noteworthy that the locking circuit 100 of the motor driver of the present disclosure sets a plurality of locking times for the motor MT, at least one of which is different from the others. Thus, the motor driver of the present disclosure can promptly restart the motor MT once the obstacles or other factors preventing the motor MT from starting properly are removed.

When the motor driving circuit 200 does not receive a locking signal from the locking circuit 100, the motor driving circuit 200 can attempt to start the motor MT. At this time, the motor MT is in a non-locking state, meaning that it is in a state where startup attempts can be made.

Conversely, when the motor driving circuit 200 receives a locking signal from the locking circuit 100, the motor driving circuit 200 stops attempting to start the motor MT during the locking time based on the received locking signal. At this time, the motor MT is in a locked state, meaning startup attempts are not allowed.

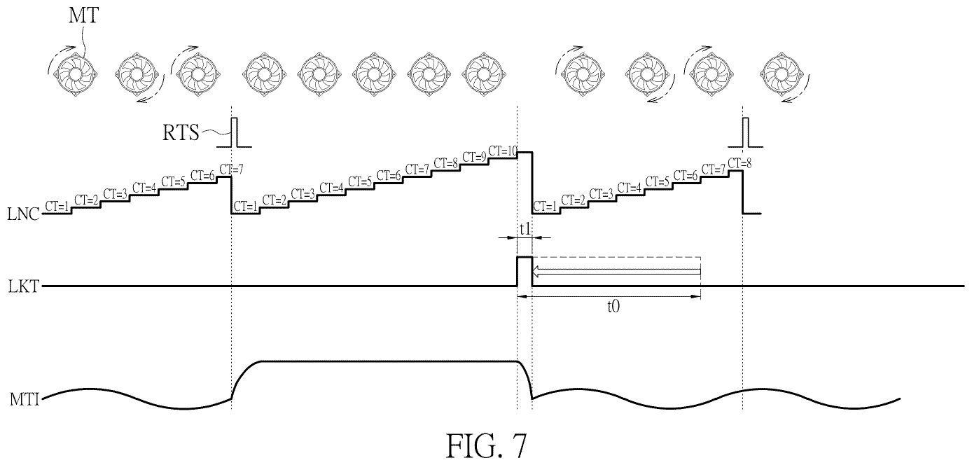

Reference is made to FIG. 2 and FIG. 7. FIG. 2 is a block diagram of the motor driver with a fail-startup fast restarting mechanism according to the second embodiment of the present disclosure, and FIG. 7 is a waveform diagram of signals in the motor driver with a fail-startup fast restarting mechanism according to the second to fourth embodiments of the present disclosure.

As shown in FIG. 2, in the second embodiment, the motor driver of the present disclosure includes a locking circuit 100 and a motor driving circuit 200. The locking circuit 100 comprises a startup attempt count circuit 101, a locking time duration setting circuit 102, and a locking startup circuit 103.

The locking startup circuit 103 is connected to the startup attempt count circuit 101, the locking time duration setting circuit 102, and the motor driving circuit 200. The motor driving circuit 200 and the startup attempt count circuit 101 are connected to the motor MT.

The startup attempt count circuit 101 detects motor MT data multiple times (including the current of the motor MT). The startup attempt count circuit 101 determines, based on each detected motor MT data, whether the motor MT has successfully started and counts the accumulated number of failed startup attempts. This information is used to determine whether to switch the motor MT from a non-locking state to a locking state.

For example, whenever the motor MT started by the motor driving circuit 200 fails to rotate from an initial position to a target position within a startup attempt threshold time duration, the startup attempt count circuit 101 determines that the motor driving circuit 200 has failed to start the motor MT. Alternatively, if the number of rotations of the motor MT within the attempt startup threshold time duration (e.g., one full rotation) does not reach a rotation threshold value, the startup attempt count circuit 101 determines that the motor driving circuit 200 has failed to start the motor MT.

The startup attempt count circuit 101 accumulates the number of failed startup attempts by the motor driving circuit 200 as a startup attempt count value or records the attempt startup duration as a startup attempt count value. Based on this startup attempt count value, the startup attempt count circuit 101 generates a startup failure count signal LNC, as shown in FIG. 7.

As shown in FIG. 7, in the startup failure count signal LNC, the startup attempt count circuit 101 increments the startup attempt count value CN to 1 during the first startup attempt of the motor MT by the motor driving circuit 200, increments the count value CN to 2 during the second startup attempt, and then continues to increment CN to 3-6 for the third to sixth startup attempts. Finally, during the seventh startup attempt of the motor MT, the startup attempt count value CN reaches 7.

Whenever the counted startup attempt count value (e.g., CN=7 as shown in FIG. 7) has not yet reached a startup failure count threshold (e.g., CN=10 as shown in FIG. 7) and the motor MT is successfully started, the startup attempt count circuit 101 generates a success startup indication signal RTS, which has a pulse or a first level, such as a high logic level.

Based on the success startup indication signal RTS, which has a pulse or a first level (e.g., high logic level), the startup attempt count circuit 101 resets the startup attempt count value CN contained in the startup failure count signal LNC to 0. The next time, the startup attempt count value CN is restarted from 0 to count the number of motor MT startup attempts.

The startup attempt count circuit 101 outputs a startup attempt count signal LNC (which includes the startup attempt count value CN) and a success startup indication signal RTS to the locking startup circuit 103.

When the locking startup circuit 103 determines that the startup attempt count value CN contained in the startup attempt count signal LNC received from the startup attempt count circuit 101 has been reset to 0 before reaching the startup failure count threshold, the locking startup circuit 103 determines that the motor MT has been successfully started. Alternatively, the locking startup circuit 103 can determine that the motor MT has successfully started based on receiving a success startup indication signal RTS from the startup attempt count circuit 101.

Furthermore, when the locking startup circuit 103 determines that the motor MT has been successfully started, it outputs a locking signal LKT with a first level (e.g., a low level). Based on the locking signal LKT with a first level (e.g., a low level), the motor driving circuit 200 does not lock the motor MT, meaning the motor MT remains in a non-locking state and is not switched to a locking state.

It is noteworthy that whenever the locking startup circuit 103 determines that the startup attempt count value (e.g., CN=10 as shown in FIG. 7) contained in the startup attempt count signal LNC received from the startup attempt count circuit 101 has reached the startup failure count threshold (e.g., CN=10 as shown in FIG. 7) and the motor MT still fails to start, the locking startup circuit 103 outputs a locking signal LKT with a second level (e.g., a high level) or a pulse. Based on the locking signal LKT with a second level (e.g., a high level) or a pulse, the motor driving circuit 200 locks the motor MT, switching it from a non-locking state to a locking state.

As shown in FIG. 7, the rising edge of the locking signal LKT represents the initial locking time point at which the motor MT transitions from a non-locking state to a locking state, marking the beginning of the locking time.

It is noteworthy that the locking time duration setting circuit 102 of the motor driver of the present disclosure can set a locking time duration for each instance of the motor MT entering a locked state and output a locking time signal LTS.

The locking time duration setting circuit 102 of the motor driver of the present disclosure can configure at least one locking time among the plurality of locking times for the motor MT to be different from the others. For example, the locking time duration setting circuit 102 can set the locking time duration when the motor MT enters a locked state for the first time to be different from the locking time durations of subsequent locked states.

For instance, the locking time duration setting circuit 102 sets the locking time duration when the motor MT enters a locked state for the first time to be equal to t1, as shown in FIG. 7, and outputs a locking time signal LTS indicating a locking time duration t1.

The locking startup circuit 103, based on the locking time duration t1 indicated by the locking time signal LTS received from the locking time duration setting circuit 102, sets the locking time duration t1 for the locking signal LKT output to the motor driving circuit 200, i.e., it sets the duty cycle or pulse width of the locking signal LKT.

The locking startup circuit 103 uses the rising edge of the pulse of the locking signal LKT as the initial locking time point for switching the motor MT to a locked state. From this initial locking time point, the motor MT remains locked for the duration of the locking time duration t1. The falling edge of the pulse of the locking time signal LTS represents the time at which the locking startup circuit 103 stops locking the motor MT, marking the end of the locking time.

The startup attempt count circuit 101 stops counting the startup attempt count value CN during the locking time duration t1 of the locking signal LKT received from the locking startup circuit 103.

After the locking time duration t1 of the locking signal LKT ends, the motor driving circuit 200 attempts to restart the motor MT, and the startup attempt count circuit 101 resumes counting the startup attempt count value CN.

The locking time duration setting circuit 102 can set a plurality of reference accumulation counts and a plurality of reference locking time durations corresponding to the plurality of reference accumulation counts. The plurality of reference accumulation counts represent the accumulated number of times the motor MT transitions to the locked state. The plurality of reference locking time durations correspond to the locking time durations for locking the motor MT when the number of transitions to the locked state reaches each of the respective accumulation counts.

The locking startup circuit 103 retrieves the reference locking time duration corresponding to the current accumulated count of the motor MT switching to a locked state and uses it as the locking time duration for the motor MT in its current locked state. Based on this locking time, the locking startup circuit 103 outputs a locking signal LKT.

The motor driving circuit 200, based on the locking signal LKT received from the startup attempt count circuit 101, sets the initial locking time point and the locking time duration for the motor MT switching to a locked state and accordingly locks the motor MT in a locked state.

For example, the locking time duration setting circuit 102 sets a plurality of reference locking time durations, including a first reference locking time duration and a second reference locking time duration. The locking time duration setting circuit 102 sets the locking time duration for the first time the motor MT switches to a locked state (i.e., reference accumulated count=1) to be equal to the first reference locking time duration (e.g., t0 as shown in FIG. 7). It also sets the locking time durations for the second and subsequent instances of the motor MT switching to a locked state (i.e., reference accumulated count=2 to N) to be equal to the second reference locking time duration (e.g., t1 as shown in FIG. 7). The first reference locking time duration is different from the second reference locking time duration, for example, the first reference locking time duration is shorter than the second reference locking time duration.

The locking time duration setting circuit 102 can obtain or set a preset locking time duration and modulate (e.g., shorten) the preset locking time duration to form a reference locking time duration, which serves as the locking time duration for the first instance (i.e., reference accumulated count=1) of the motor MT switching to a locked state. The locking time duration setting circuit 102 can set the locking time duration for the second and subsequent instances (i.e., reference accumulated count=2 to N) of the motor MT switching to a locked state to be equal to the preset locking time duration.

Therefore, when the motor driving circuit 200 of the motor driver in the present disclosure fails to start the motor MT in the first or earliest non-locking period, the locking time duration is shorter, allowing the motor driving circuit 200 to attempt to restart the motor MT more quickly. However, when the motor MT still fails to start in the subsequent non-locking periods, the locking time duration setting circuit 102 determines that the factors causing the startup failure cannot be resolved in a short time, such as an increasing accumulation of dust or other obstacles on the motor MT. In this case, the motor driving circuit 200 waits for a longer locking time before attempting to restart the motor MT again.

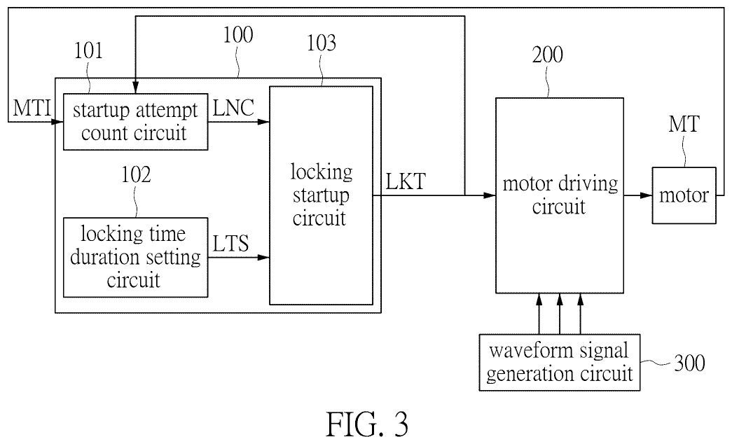

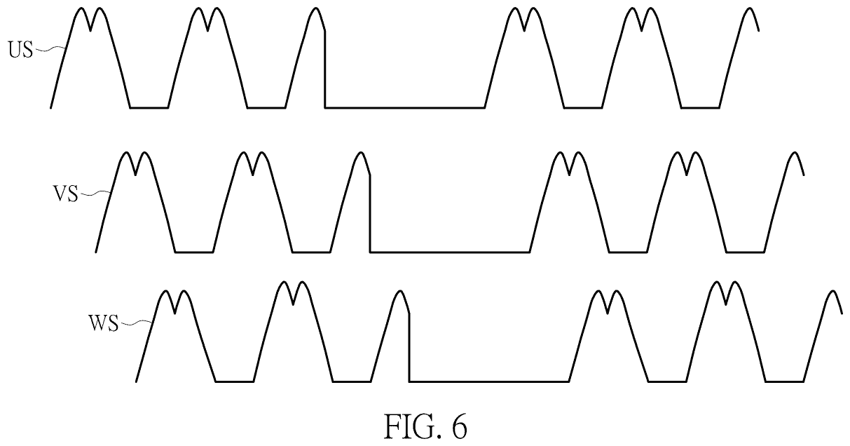

Reference is made to FIG. 3 and FIG. 6. FIG. 3 is a block diagram of a motor driver with a fail-startup fast restarting mechanism according to the third embodiment of the present disclosure, and FIG. 6 is a waveform diagram of signals in the motor driver with a fail-startup fast restarting mechanism according to the first to fourth embodiments of the present disclosure.

The third embodiment of the present disclosure shares similarities with the second embodiment and will not be redundantly described herein.

The difference between the third and second embodiments of the present disclosure is that, as shown in FIG. 3, the motor driver in the third embodiment includes a waveform signal generation circuit 300 in addition to the locking circuit 100 and the motor driving circuit 200. The waveform signal generation circuit 300 is connected to the motor driving circuit 200.

The waveform signal generation circuit 300 outputs multiple startup pattern waveform signals, where each startup pattern waveform signal comprises multiple waveforms. These multiple waveforms may include multiple sinusoidal waveforms, multiple third-harmonic waveforms, or any combination thereof.

The motor driving circuit 200 modulates the plurality of startup pattern waveform signals received from the waveform signal generation circuit 300 according to the locking signal LKT received from the locking startup circuit 103 to generate multiple startup waveform signals. The motor MT is driven based on the plurality of startup waveform signals.

For example, when the motor driving circuit 200 does not receive a locking signal LKT from the locking startup circuit 103, the motor driving circuit 200 outputs multiple complete waveforms, such as multiple third-harmonic waveforms, from the startup waveform signals US, VS, and WS, as shown in FIG. 6, to the motor MT during a non-locking period. Alternatively, the motor driving circuit 200 generates a motor startup signal based on the plurality of complete waveforms of the startup waveform signals US, VS, and WS to attempt to start the motor MT.

Conversely, when the motor driving circuit 200 receives a locking signal LKT from the locking startup circuit 103, it removes or cuts off certain frequency bands from at least one waveform of the plurality of startup pattern waveform signals during the locking time. The motor driving circuit 200 then outputs the modified startup pattern waveform signals as the startup waveform signals US, VS, and WS, as shown in FIG. 6. Consequently, each startup waveform signal US, VS, WS in FIG. 6 has incomplete waveforms, such as incomplete third-harmonic waveforms.

In other words, during the locking time specified by the locking signal LKT received from the locking startup circuit 103, the motor driving circuit 200 stops outputting certain frequency bands of at least one waveform in the startup waveform signals US, VS, and WS, thereby stopping the motor startup attempt.

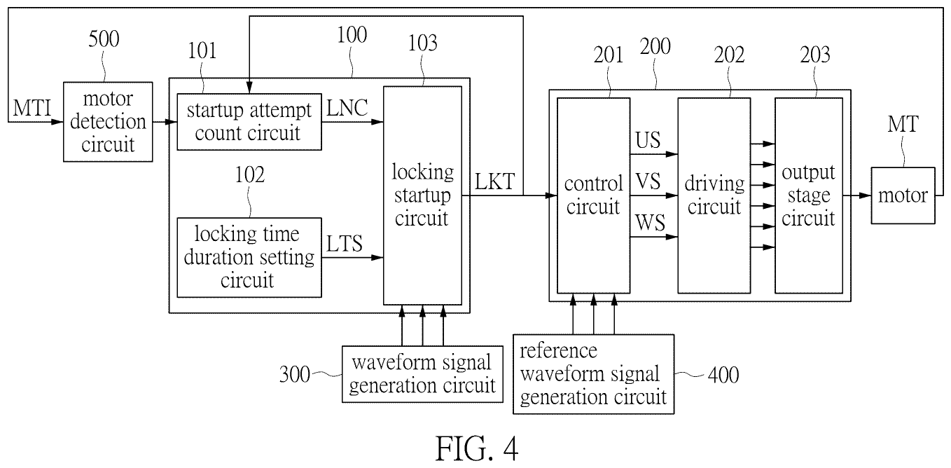

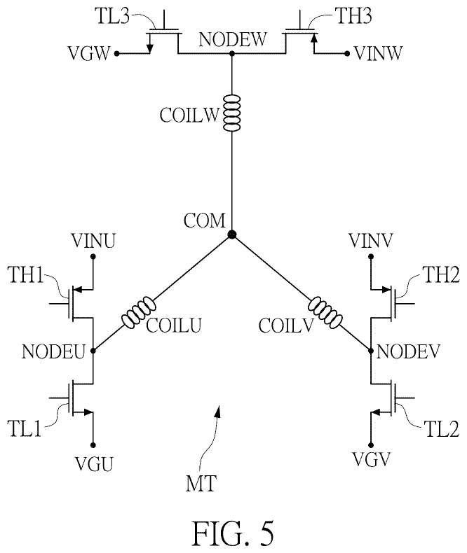

Reference is made to FIG. 4 and FIG. 5, in which FIG. 4 is a block diagram of a motor driver with a fail-startup fast restarting mechanism according to the fourth embodiment of the present disclosure, and FIG. 5 is a circuit diagram illustrating the output stage circuit and motor configuration of the motor driver with a fail-startup fast restarting mechanism according to the fourth embodiment. The similarities between the fourth embodiment and the first to third embodiments of the present disclosure will not be redundantly described herein.

In addition to the locking circuit 100, the motor driving circuit 200, and the waveform signal generation circuit 300, the motor driver in the fourth embodiment further includes a reference waveform signal generation circuit 400 and a motor detection circuit 500. In practice, the motor detection circuit 500 may be omitted.

The locking circuit 100 comprises a startup attempt count circuit 101, a locking time duration setting circuit 102, and a locking startup circuit 103. The motor driving circuit 200 comprises a control circuit 201, a driving circuit 202, and an output stage circuit 203.

The motor detection circuit 500 is connected to the motor MT and the startup attempt count circuit 101. The locking startup circuit 103 is connected to the startup attempt count circuit 101, the locking time duration setting circuit 102, and the waveform signal generation circuit 300. The control circuit 201 is connected to the reference waveform signal generation circuit 400 and the driving circuit 202. The output stage circuit 203 is connected to the driving circuit 202 and the motor MT.

The motor detection circuit 500 repeatedly detects data of the motor MT, including the motor current MTI, as shown in FIG. 7.

The startup attempt count circuit 101 determines whether the motor MT has been successfully started based on the data detected by the motor detection circuit 500 for the detection. It also counts the accumulated number of failed motor MT startup attempts and, accordingly, sets an initial locking time point for switching the motor MT from an unlocked state to a locked state, thereby outputting a startup failure count signal LNC.

The control circuit 201 modulates the plurality of startup pattern waveform signals received from the waveform signal generation circuit 300 according to the locking signal LKT received from the locking startup circuit 103 to generate multiple startup waveform signals US, VS, WS, as shown in FIG. 6. Each startup waveform signal US, VS, WS includes multiple sinusoidal waveforms, multiple third-harmonic waveforms, or any combination thereof.

The driving circuit 202 generates multiple driving signals based on the plurality of startup waveform signals US, VS, WS and multiple reference pattern waveform signals received from the control circuit 201. For example, the driving circuit 202 compares the voltage levels of the plurality of startup waveform signals US, VS, WS with the voltage levels of the plurality of reference pattern waveform signals to determine the voltage levels of the plurality of driving signals.

The output stage circuit 203 operates according to the plurality of driving signals received from the driving circuit 202 and outputs a motor startup signal to the motor MT to initiate motor startup.

For example, as shown in FIG. 4, the output stage circuit 203 may include a first high-side switch TH1, a first low-side switch TL1, a second high-side switch TH2, a second low-side switch TL2, a third high-side switch TH3, and a third low-side switch TL3, as shown in FIG. 5.

The first terminal of the first high-side switch TH1 is coupled to a first input voltage VINU. The second terminal of the first high-side switch TH1 is connected to the first terminal of the first low-side switch TL1. The second terminal of the first low-side switch TL1 is coupled to a first reference potential VGU. The node NODEU between the second terminal of the first high-side switch TH1 and the first terminal of the first low-side switch TL1 is connected to the first coil COILU of the first phase (e.g., U phase) of the motor MT, which may be a three-phase motor.

The first terminal of the second high-side switch TH2 is coupled to a second input voltage VINV. The second terminal of the second high-side switch TH2 is connected to the first terminal of the second low-side switch TL2. The second terminal of the second low-side switch TL2 is coupled to a second reference potential VGV. The node NODEV between the second terminal of the second high-side switch TH2 and the first terminal of the second low-side switch TL2 is connected to the first end of the second coil COILV of the second phase (e.g., V phase) of the motor MT.

The first terminal of the third high-side switch TH3 is coupled to a third input voltage VINW. The second terminal of the third high-side switch TH3 is connected to the first terminal of the third low-side switch TL3. The second terminal of the third low-side switch TL3 is coupled to a third reference potential VGW. The node NODEW between the second terminal of the third high-side switch TH3 and the first terminal of the third low-side switch TL3 is connected to the first end of the third coil COILW of the third phase (e.g., W phase) of the motor MT.

The second ends of the first coil COILU, the second coil COILV, and the third coil COILW of the motor MT (e.g., a three-phase motor) are connected to a common node COM.

The control terminals of the first high-side switch TH1, the first low-side switch TL1, the second high-side switch TH2, the second low-side switch TL2, the third high-side switch TH3, and the third low-side switch TL3 are connected to the driving circuit 202 to receive multiple driving signals from the driving circuit 202.

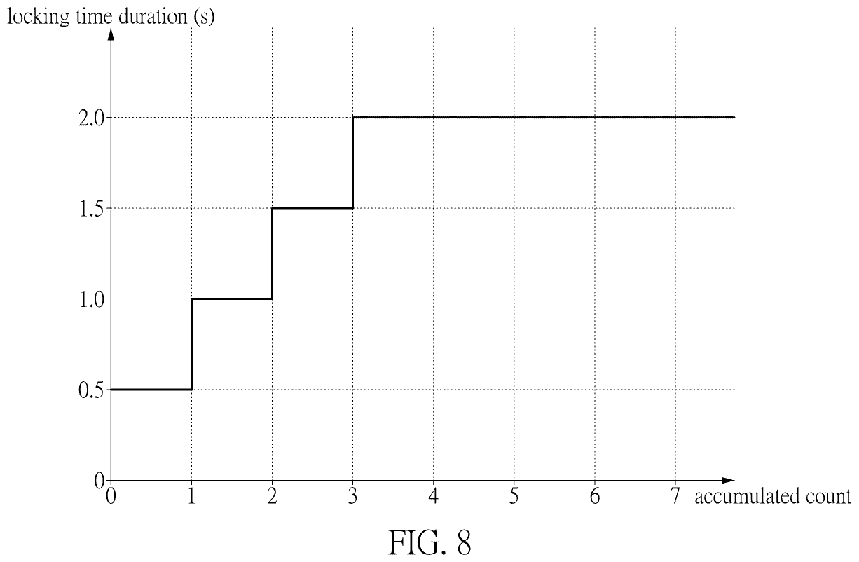

Reference is made to FIG. 8, which is a schematic diagram illustrating multiple locking time durations corresponding to multiple accumulated locking transitions in the motor driver with a fail-startup fast restarting mechanism according to the fifth embodiment of the present disclosure.

As shown in FIGS. 2 to 4, the startup attempt count circuit 101 accumulates the number of startup attempts of the motor MT. The locking time duration setting circuit 102 sets the plurality of reference accumulated counts and their corresponding multiple locking time durations.

As shown in FIG. 8, the locking time duration setting circuit 102 sets the locking time duration for the first time the motor MT switches to a locked state (i.e., accumulated count=1) to be equal to a first reference locking time duration, for example, 0.5 seconds.

The locking time duration setting circuit 102 sets the locking time duration for the second time the motor MT switches to a locked state (i.e., accumulated count=2) to be equal to a second reference locking time duration, for example, 1 second.

The locking time duration setting circuit 102 sets the locking time duration for the third time the motor MT switches to a locked state (i.e., accumulated count=3) to be equal to a third reference locking time duration, for example, 1.5 seconds.

When the accumulated count of locking transitions exceeds a locking count threshold (i.e., accumulated count>3), for example, when the motor MT switches to a locked state for the fourth to seventh times (accumulated count=4 to 7) as shown in FIG. 8, the locking time duration setting circuit 102 sets the locking time duration to be equal to a fourth reference locking time duration or a preset locking time duration, for example, 2 seconds.

It is noteworthy that the motor driver of the present disclosure allows flexible configuration of different locking time durations for multiple instances of the motor MT switching to a locked state. For example, as shown in FIG. 8, when the accumulated count of motor MT switching to a locked state is low, the locking time duration is shorter; conversely, as the accumulated count of motor MT switching to a locked state increases, the locking time duration becomes longer. However, when the accumulated count of switching to a locked state exceeds a locking count threshold, the locking time duration may no longer increase and can be maintained at a preset locking time duration.

In summary, the present disclosure provides a motor driver with a fail-startup fast restarting mechanism. The motor driver of the present disclosure enables flexible configuration of different locking time durations after each failed attempt startup, ensuring that the locking time duration varies for multiple consecutive startup failures. For example, the motor driver of the present disclosure can set the locking time duration for the first transition of motor locking to be shorter than subsequent transitions, reducing the waiting time before the second startup attempt. This allows an earlier second startup attempt, thus improving the startup success rate of the motor driver compared to conventional motor drivers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver with a fail-startup fast restarting mechanism, comprising:
a locking circuit, configured to set a plurality of locking times during which a motor enters a locked state, wherein at least one of the plurality of locking times is different from others in terms of locking time duration; and
a motor driving circuit, connected to the locking circuit and the motor, and configured to attempt to start the motor during one or more non-locking times other than the plurality of locking times, and to stop attempting to start the motor during each of the plurality of locking times.

2. The motor driver with a fail-startup fast restarting mechanism according to Claim 1, wherein the motor enters the locked state whenever the locking circuit determines that the motor driving circuit has failed to start the motor.

3. The motor driver with a fail-startup fast restarting mechanism according to Claim 2, wherein the locking circuit is configured to obtain or detect motor data to determine whether the motor driving circuit has failed to start the motor.

4. The motor driver with a fail-startup fast restarting mechanism according to Claim 2, wherein the locking circuit determines that the motor driving circuit has failed to start the motor whenever the motor driven by the motor driving circuit does not rotate from an initial position to a target position within a startup attempt threshold time duration.

5. The motor driver with a fail-startup fast restarting mechanism according to Claim 2, wherein the locking circuit determines that the motor driving circuit has failed to start the motor whenever a number of rotations of the motor driven by the motor driving circuit does not reach a rotation threshold value within a startup attempt threshold time duration.

6. The motor driver with a fail-startup fast restarting mechanism according to
Claim 1, wherein the locking circuit is configured to count an accumulated number of failed startup attempts of the motor driving circuit or measure a startup attempt time duration as a startup attempt count value;
wherein the motor enters the locked state when the startup attempt count value reaches a startup attempt threshold time duration.

7. The motor driver with a fail-startup fast restarting mechanism according to Claim 6, wherein, after the motor driving circuit successfully starts the motor, the locking circuit resets the startup attempt count value.

8. The motor driver with a fail-startup fast restarting mechanism according to Claim 1, wherein the locking circuit is configured to modulate a preset locking time duration to form a reference locking time duration, which serves as a locking time duration for a first transition of the motor switching to the locked state.

9. The motor driver with a fail-startup fast restarting mechanism according to Claim 1, wherein the locking circuit is configured to shorten a preset locking time duration to form a reference locking time duration, which serves as the locking time duration for a first transition of the motor switching to the locked state.

10. The motor driver with a fail-startup fast restarting mechanism according to Claim 9, wherein the locking circuit is configured to set the locking time duration for a second and subsequent transitions of the motor switching to the locked state to be equal to the preset locking time duration.

11. The motor driver with a fail-startup fast restarting mechanism according to Claim 1, wherein the locking circuit is configured to set the locking time duration for the first transition of the motor switching to the locked state to a first reference locking time duration, and to set the locking time duration for the second and subsequent transitions of the motor switching to the locked state to a second reference locking time duration.

12. The motor driver with a fail-startup fast restarting mechanism according to Claim 11, wherein the first reference locking time duration is different from the second reference locking time duration.

13. The motor driver with a fail-startup fast restarting mechanism according to Claim 1, wherein the locking circuit comprises:
a startup attempt count circuit, configured to determine whether to switch the motor from a non-locking state to a locked state based on an operational state signal of the motor, and to count an accumulated number of times the motor has switched from the non-locking state to the locked state;
a locking time duration setting circuit, connected to the startup attempt count circuit, and configured to set a plurality of reference accumulated counts and a plurality of reference locking time durations corresponding to the plurality of reference accumulated counts; and
a locking startup circuit, connected to the startup attempt count circuit, the locking time duration setting circuit, and the motor driving circuit, and configured to obtain a reference locking time duration corresponding to a currently counted accumulated number of times that the motor has switched to the locked state, and to use the reference locking time duration corresponding to the currently counted accumulated number of times that the motor has switched to the locked state as a locking time duration for a current transition of the motor to the locked state.

14. The motor driver with a fail-startup fast restarting mechanism according to Claim 1, further comprising:
a waveform signal generation circuit, connected to the motor driving circuit, and configured to generate a startup pattern waveform signal;
wherein the motor driving circuit is configured to modulate the startup pattern waveform signal according to the plurality of locking times to form a startup waveform signal, and to start the motor based on the startup waveform signal.

15. The motor driver with a fail-startup fast restarting mechanism according to

14. wherein the motor driving circuit is configured to cut or remove frequency bands of at least one waveform of the startup pattern waveform signal that are generated during the locking time, to form the startup waveform signal.

16. The motor driver with a fail-startup fast restarting mechanism according to Claim 14, wherein the startup pattern waveform signal comprises a plurality of sinusoidal waveforms, a plurality of third-harmonic waveforms, or any combination thereof.

17. The motor driver with a fail-startup fast restarting mechanism according to Claim 1, wherein the motor comprises a three-phase motor.

18. The motor driver with a fail-startup fast restarting mechanism according to Claim 1, wherein the motor comprises a single-phase motor.
